(19) United States
(12) Patent Application Publication
(10) Pub. No.: US 2014/0291786 A1
(43) Pub. Date: Oct. 2, 2014

(54) component having a micromechanical microphone structure

(71) Applicants: Jochen Zoellin, Muellheim (DE); Franz Laermer, Weil Der Stadt (DE); Christoph Schelling, Stuttgart (DE); Mike Daley, Canonsburg, PA (US)

(72) Inventors: Jochen Zoellin, Muellheim (DE); Franz Laermer, Weil Der Stadt (DE); Christoph Schelling, Stuttgart (DE); Mike Daley, Canonsburg, PA (US)

(21) Appl. No.: 14/233,969

(22) PCT Filed: Jul. 20, 2012
(86) PCT No.: PCT/EP2012/064251

§ 371 Date: Jun. 18, 2014

(30) Foreign Application Priority Data
Jul. 21, 2011 (DE) 10 2011 079 516.2
Jan. 24, 2012 (DE) 10 2012 200 957.4

(51) Int. Cl. H04R 7/06; H04R 19/00; H04R 19/04

(52) U.S. Cl. CPC H04R 7/06; H04R 19/04; H04R 19/005; H04R 2201/003
USPC 257/416

(57) ABSTRACT

Substrate-side overload protection for the diaphragm structure of a microphone component having a micromechanical microphone structure which impairs the damping properties of the microphone structure as little as possible, in which the microphone structure includes a diaphragm structure having at least one acoustically active diaphragm which is formed in a diaphragm layer above a semiconductor substrate. The diaphragm structure spans at least one sound opening in the rear side of the substrate. A stationary, acoustically permeable counter element is formed in the layer structure of the component above the diaphragm layer. According to the invention, at least projections are formed at the outer edge area of the diaphragm structure which protrude beyond the edge area of the sound opening, so that the edge area of the sound opening acts as a substrate-side stop for the diaphragm structure.

### FIELD OF THE INVENTION

The present invention relates to a component having a micromechanical microphone structure which is implemented in a layer structure on a semiconductor substrate. The microphone structure includes a diaphragm structure having an acoustically active diaphragm, the diaphragm structure being formed in a diaphragm layer above the semiconductor substrate and spanning at least one sound opening in the rear side of the substrate. In addition, the microphone structure includes a stationary, acoustically permeable counter element which is formed in the layer structure above the diaphragm layer, and substrate-side overload protection for the diaphragm structure.

### BACKGROUND INFORMATION

Structural elements such as spring elements are frequently formed in the edge area of a microphone diaphragm, via which the diaphragm is integrated into the layer structure of the component. On the one hand, this type of suspension has the function of absorbing manufacturing- and temperature-related mechanical stresses in the thin diaphragm structure and preventing this intrinsic stress from resulting in the deformation of the diaphragm. On the other hand, a spring suspension assists in maximizing the useful microphone signal, since sound pressure-related deformations of the diaphragm structure also occur, which may be in the area of the spring elements, while the diaphragm is deflected essentially in a plane-parallel manner.

However, the diaphragm structure of a microphone component responds not only to acoustically related pressure fluctuations, but also to pressure fluctuations and accelerations to which the microphone component is exposed in the production process and during use, for example when the device equipped with the microphone component falls to the floor. Overload situations may thus occur which result in damage to the diaphragm structure. The edge area of the diaphragm structure is particularly susceptible, since the greatest deformation and the highest stress occur in this area. In the microphone component under discussion, the diaphragm deflection is limited in one direction by the counter element situated above the diaphragm structure. Overload protection on the substrate side is provided for limiting the diaphragm deflection in the other direction.

Patent document US 2002/0067663 A1 discusses a microphone component of the type mentioned at the outset, whose micromechanical microphone structure is implemented in a layer structure above a semiconductor substrate. In this case the diaphragm structure is formed in a diaphragm layer which is electrically insulated from the semiconductor substrate by a dielectric layer on the substrate surface and a narrow air gap. The circular diaphragm of the diaphragm structure spans an essentially square sound opening in the rear side of the substrate which tapers in a pyramidal shape from the rear side of the substrate toward the diaphragm, so that the outer edge of the diaphragm and the edge area of the sound opening overlap, at least in part. The edge area of the sound opening thus forms a substrate-side stop for the diaphragm structure. Separated by a further air gap, a perforated counter element is situated above the diaphragm structure and forms a pedestal-like elevation on the component surface.

The sound-related diaphragm movement, and thus also the output signal of the microphone, is damped by the overlap of the outer edge of the diaphragm and the edge area of the pyramid-shaped sound opening. The greater the overlap, the higher the degree of damping. Since such damping generally is not desirable, but effective overload protection requires a certain minimum overlap, the substrate-side stop discussed in US 2002/0067663 A1 has only limited suitability as overload protection for the diaphragm structure of a microphone component.

### SUMMARY OF THE INVENTION

The present invention provides options for achieving substrate-side overload protection for the diaphragm structure of a microphone component of the type mentioned at the outset which impair the damping properties of the microphone structure as little as possible. All claimed forms of implementation are based on the concept of utilizing the edge area of the sound opening as a substrate-side stop without significantly reducing the opening surface area of the sound opening in comparison to the diaphragm surface area.

In the form of implementation described herein, projections are formed at the outer edge area of the diaphragm structure which protrude beyond the edge area of the sound opening, so that via the projections, the edge area of the sound opening acts as a substrate-side stop for the diaphragm structure.

These projections together with the spring suspension of the diaphragm may be easily structured from the diaphragm layer, so that they require no additional manufacturing effort. The projections may be easily implemented in the form of outwardly protruding finger-like webs, or may also have any other geometry that is coordinated with the size and shape of the component. Depending on the width of the projections, an advantageous effect on the damping behavior of the microphone structure may result when the projections formed at the outer edge of the diaphragm structure are provided with through openings.

With regard to the microphone performance, it has proven advantageous for the diameter of the sound opening in the rear side of the substrate to be much larger than the diameter of the microphone diaphragm. In this case, the projections on the diaphragm structure must be relatively long in order to fulfill their function as substrate-side overload protection for the diaphragm structure. However, this may prove to be problematic in practice, since manufacturing-related mechanical stresses occur in the very thin diaphragm structure which result in bending of the diaphragm structure. Due to the geometry of the diaphragm structure, the bending of the projections is generally much greater than the bending of the microphone diaphragm.

The bending of the projections, depending on their geometry and configuration, may even be so great that the microphone function of the component is significantly impaired. In one particularly advantageous specific embodiment of the component according to the present invention, this problem is addressed by forming web-like connecting elements between the projections at the outer edge of the diaphragm structure. These connecting elements alter the stress conditions within the diaphragm structure, and due to their arrangement between the projections, counteract a bending of the projections without impairing the diaphragm sensitivity. The connecting elements also assist in protecting and stabilizing the individual projections. Namely, the forces which occur in overload situations are uniformly distributed over all projections with the aid of the connecting elements, so that a rupture in the diaphragm structure occurs less frequently.

The connecting webs together with the projections and the rest of the diaphragm structure are advantageously produced in the diaphragm layer and exposed, so that no additional manufacturing effort is involved. The connecting webs, the same as the projections, may also be provided with through openings in order to improve the damping behavior of the microphone structure.

As an alternative or in addition to the above-described projections of the diaphragm structure, according to another claimed form of implementation of the present invention, bar-like structural elements are formed in the edge area of the sound opening which project to below the diaphragm, so that the bar-like structural elements act as a substrate-side stop for the diaphragm.

These bar-like structural elements are advantageously so narrow that they do not significantly reduce the opening surface area of the sound opening. They may be easily produced together with the sound opening in the substrate by appropriately masking the rear side of the substrate in an anisotropic etching process, which likewise requires no appreciable additional manufacturing effort. In this case, the bar-like structural elements extend in the edge area of the sound opening essentially over the entire thickness of the substrate. Depending on the shape and size of the diaphragm, it may be advantageous to form at least one bar-like web in the edge area of the sound opening, the web extending from one side of the sound opening to the opposite side, so that the diaphragm also has a substrate-side stop in the center area.

Of course, both forms of stops may also advantageously be combined with one another.

As discussed above, there are various options for advantageously embodying and refining the teaching of the present invention. For this purpose, on the one hand reference is made to the claims which are subordinate to the independent patent claims, and on the other hand to the following description of several exemplary embodiments of the present invention, with reference to the figures.

### BRIEF DESCRIPTION OF THE DRAWINGS

FIG. 1a shows a top view of the rear side of a component 10 according to the present invention, with outer projections on the diaphragm structure.

FIG. 1b shows a schematic sectional illustration of the microphone structure of component 10.

FIG. 2a shows a top view of the rear side of a component 101 according to the present invention, with outer projections on the diaphragm structure and web-like connecting elements between these projections.

FIG. 2b shows a schematic sectional illustration of the microphone structure of component 101.

FIG. 3 shows a top view of the rear side of a further component 102 according to the present invention, with outer projections on the diaphragm structure and web-like connecting elements between these projections.

FIG. 4a shows a top view of the rear side of a component 20 according to the present invention, with bar-like structural elements in the edge area of the sound opening.

FIG. 4b shows a schematic sectional illustration of the microphone structure of component 20.

FIG. 5a shows a top view of the rear side of a first component 30 according to the present invention, having a lattice structure in the area of the sound opening.

FIG. 5b shows a top view of the rear side of a second component 40 according to the present invention, having a lattice structure in the area of the sound opening.

### DETAILED DESCRIPTION

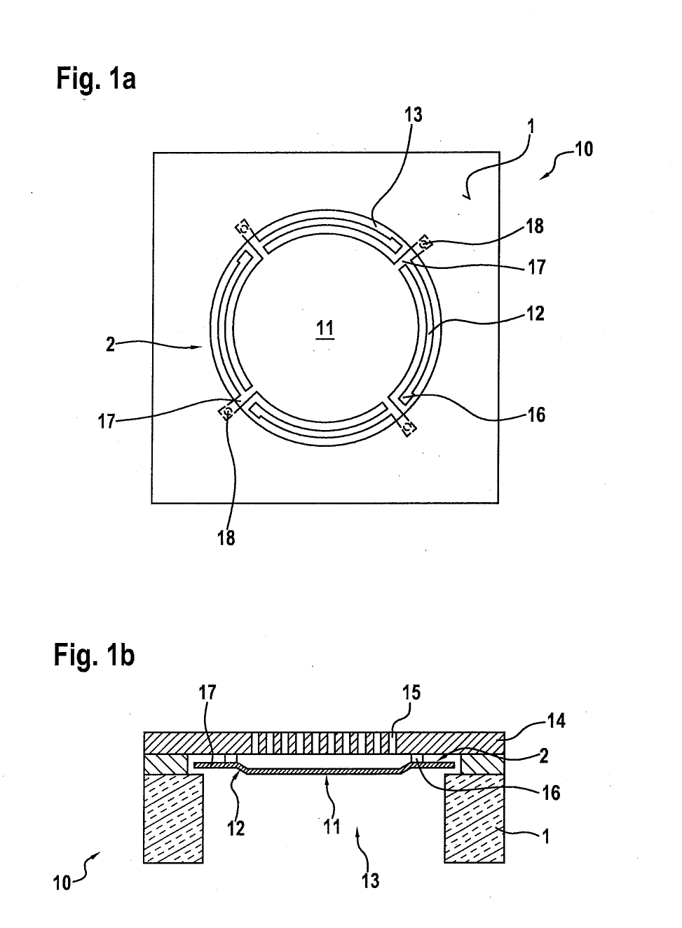

The microphone structure of MEMS microphone component 10 illustrated in FIGS. 1a and 1b is implemented in a layer structure on a semiconductor substrate 1. The microphone structure includes a diaphragm structure 2 having an acoustically active diaphragm 11 which in the exemplary embodiment described here is circular, and which acts as the deflectable electrode of a microphone capacitor. The microphone structure is integrated into the layer structure of component 10 via four spring elements 12. FIG. 1a shows the layout of diaphragm structure 2, while FIG. 1b illustrates the layer structure of component 10.

Overall diaphragm structure 2 is formed in a relatively thin diaphragm layer above semiconductor substrate 1, which may be composed of one or also multiple material layers. Accordingly, spring elements 12 are made of the same material as diaphragm 11. The layout of the spring suspension, i.e., the number, configuration, and shape of spring elements 12, has been selected as a function of the size and shape of diaphragm 11, so that the manufacturing- and temperature-related stresses which occur in thin diaphragm structure 2 are essentially absorbed by spring elements 12 and do not result in the deformation of diaphragm 11. As a result, the sensitivity of diaphragm 11 to sound pressure is determined primarily by its flexural strength. The spring suspension of diaphragm 11 also assists in maximizing the useful microphone signal, since sound pressure-related deformations of diaphragm structure 2 also occur, which may be in the area of spring elements 12, while diaphragm 11, which contributes to the measuring capacity, is deflected with respect to the counter electrode of the microphone capacitor in essentially a plane-parallel manner.

Diaphragm structure 2 spans a cylindrical sound opening 13 in the rear side of semiconductor substrate 1.

A stationary, acoustically permeable counter element 14 is formed in the layer structure above the diaphragm layer, and acts as a support for the counter electrode of the microphone capacitor. Counter element 14 has perforation-like through openings 15 in the area above diaphragm 11 which are used for de-attenuating the microphone structure.

Since the diameter of sound opening 13 in the present exemplary embodiment is larger than that of diaphragm 11, the spring suspension here is connected to counter element 14. These connecting points are denoted by reference numeral 16 in FIG. 1b. If the sound opening extended only over the area of the diaphragm, the spring suspension could just as well be integrated into the layer structure on the substrate side.

Counter element 14 limits the upward deflection of diaphragm 11, and thus acts as overload protection, at least on this side.

For achieving substrate-side overload protection for diaphragm structure 2, projections 17 are formed at the outer edge area of diaphragm structure 2, and protrude beyond the edge area of sound opening 13 so that the edge area of sound opening 13 acts as a substrate-side stop for projections 17, and thus for diaphragm structure 2 overall. Projections 17, the same as diaphragm 11 and spring elements 12, are structured from the diaphragm layer of the layer structure.

In the exemplary embodiment illustrated here, diaphragm structure 2 includes four such projections 17 which protrude outwardly in a finger-like manner. Projections 17 are each situated at the connecting point of a spring element 12 to diaphragm 11. At this point, however, it is expressly noted that the number and configuration of projections 17 may also be selected independently of the number and position of spring elements 12. Thus, the projections do not necessarily have to protrude outwardly from a spring element 12, and instead, when the spring suspension has an appropriate design, may, for example, also be directly connected to diaphragm 11, and may protrude outwardly from the diaphragm. In addition, the shape of projections 17 may be different, provided that they are coordinated with the geometry of sound opening 13, and the edge area of sound opening 13 forms a substrate-side stop for projections 17.

In the exemplary embodiment illustrated here, projections 17 of the diaphragm structure have perforation-like through openings 18. These through openings 18 on the one hand assist in de-attenuating the microphone structure. On the other hand, they are used as etching access points for undercutting the diaphragm structure.

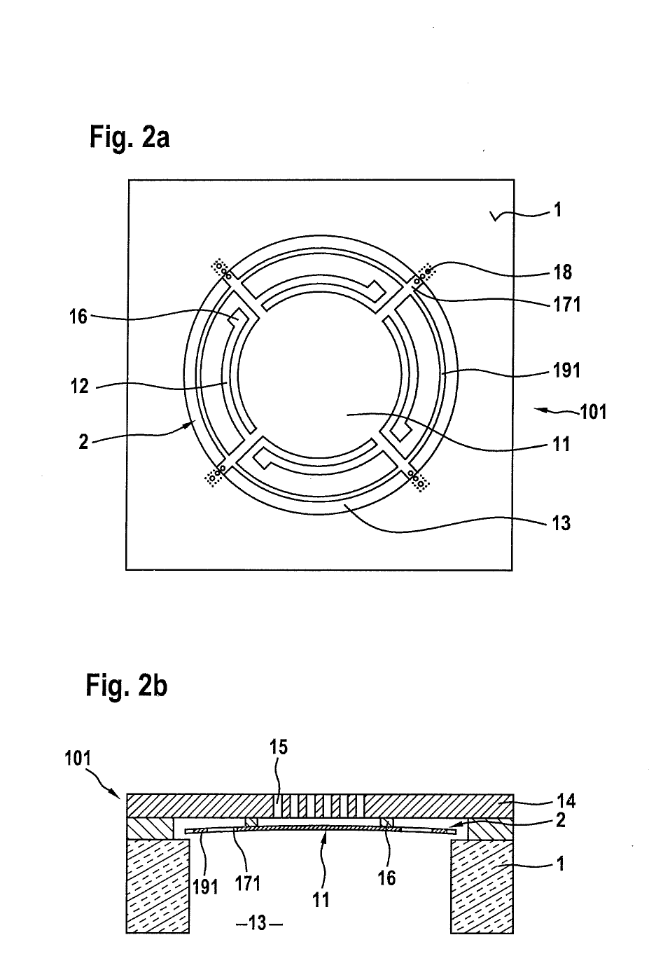

FIGS. 2a and 2b show a MEMS microphone component 101 whose microphone structure essentially corresponds to that of MEMS microphone component 10 illustrated in FIGS. 1a and 1b. Therefore, identical reference numerals are used for identical components. Reference is made to the above description of FIGS. 1a and 1b for explanation of these components.

The same as for MEMS microphone component 10, diaphragm structure 2 of MEMS microphone component 101 includes a circular, acoustically active diaphragm 11 which is integrated into the layer structure of component 101 via four spring elements 12 and is connected to counter element 14 above the diaphragm structure. Diaphragm 11 is situated above a cylindrical sound opening 13 in semiconductor substrate 1. In contrast to the exemplary embodiment illustrated in FIGS. 1a and 1b, the diameter of sound opening 13 here is much larger than the diameter of diaphragm 11.

Stationary, acoustically permeable counter element 14 above. diaphragm 11 limits the upward deflection thereof and thus acts as overload protection, at least on this side. The same as for MEMS microphone component 10, the substrate-side overload protection constitutes cooperation of the four projections 171 at the outer edge area of diaphragm structure 2 and the edge area of sound opening 13, since these projections 171 protrude beyond the edge area of sound opening 13.

FIG. 2a shows the layout of diaphragm structure 2, while FIG. 2b illustrates the layer structure of component 101.

The relatively long finger-like projections 171, the same as diaphragm 11 and spring elements 12, are structured from the diaphragm layer of the layer structure, which is thin in comparison to semiconductor substrate 1. More or less intense manufacturing- and temperature-related stresses occur in overall diaphragm structure 2, and result in a more or less pronounced curvature of the particular structural component. To counteract this type of deformation of projections 171 of diaphragm structure 2, in the exemplary embodiment illustrated here the four projections 171 are connected via web-like connecting elements 191. Connecting elements 191 circularly enclose diaphragm 11 together with spring elements 12.

The number, geometry, and configuration of these types of connecting elements between the projections are essentially a function of the geometric parameters of the microphone structure, in particular the size and shape of the diaphragm, the size and shape of the sound opening, and the shape, number, and configuration of the projections at the outer edge of the diaphragm structure. Thus, for example, it may be meaningful to provide a connecting element only between every other projection at the periphery of the diaphragm structure, or even to connect all projections at the periphery of the diaphragm structure via a double ring structure.

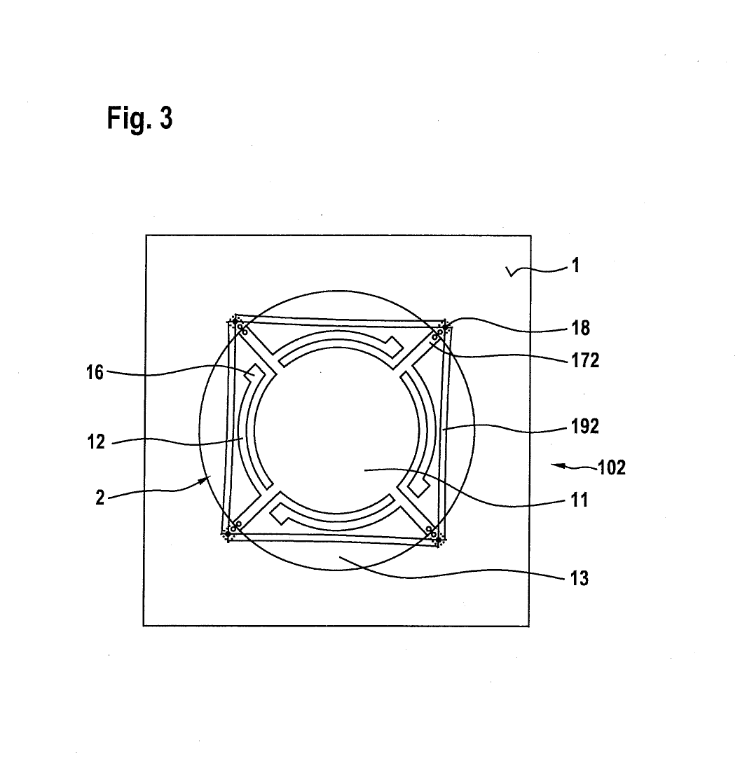

As mentioned above, in the case of MEMS microphone component 101 the ring structure of connecting elements 191 is circular, the same as diaphragm 11, and is concentric with respect to the diaphragm. In this regard, variations are also possible, as illustrated in FIG. 3. MEMS microphone component 102 illustrated here differs from MEMS microphone component 101 in FIGS. 2a and 2b solely in the configuration and shape of connecting elements 192 between projections 172. In this case, connecting elements 192 in each case connect the free ends of two projections 172 and form an essentially square frame for circular diaphragm 11.

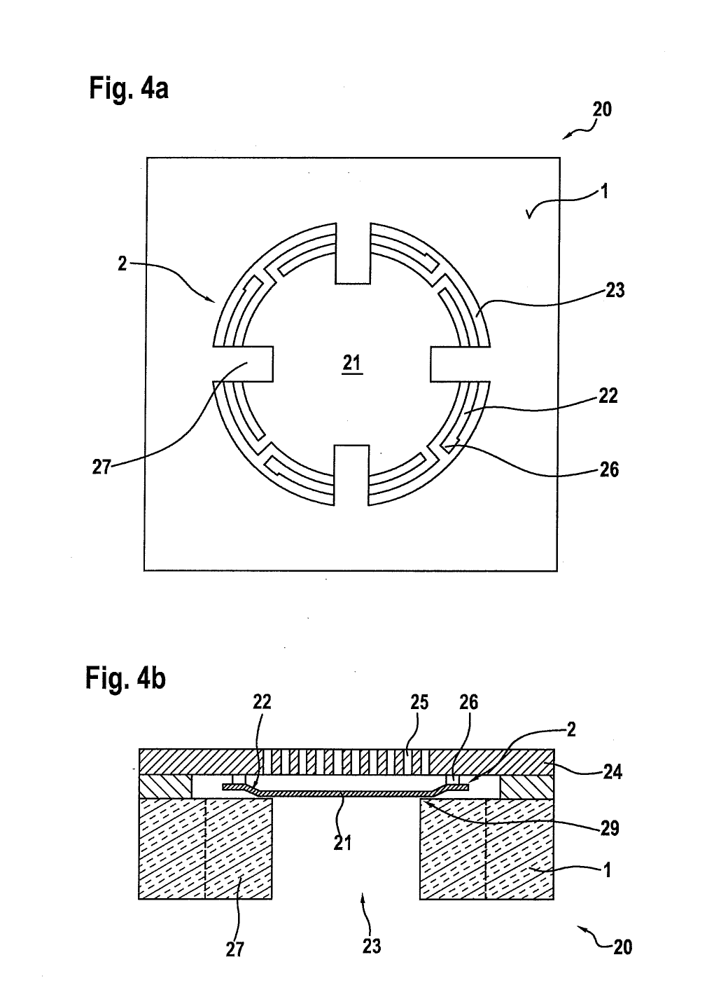

FIGS. 4a and 4b likewise show a MEMS microphone component 20 which is implemented in a layer structure on a semiconductor substrate 1. Here as well, the microphone structure includes a diaphragm structure 2 having a circular, acoustically active diaphragm 21 which acts as a deflectable electrode of a microphone capacitor and which is integrated into the layer structure of component 20 via four spring elements 22.

FIG. 4a shows the layout of diaphragm structure 2 which, the same as for component 10, is formed in a relatively thin diaphragm layer above semiconductor substrate 1 and spans a cylindrical sound opening 23 in the rear side of semiconductor substrate 1. A stationary, acoustically permeable counter element 24 is formed in the layer structure above the diaphragm layer, and acts as a support for the counter electrode of the microphone capacitor and limits the upward deflection of diaphragm 21. Here as well, the spring suspension of diaphragm 21 is connected to counter element 24 via four connecting points 26. Counter element 24 has perforation-like through openings 25 in the area above diaphragm 21 for de-attenuating the microphone structure.

The substrate-side overload protection for diaphragm structure 2 of component 20 is achieved in the form of bar-like structural elements 27 which are formed in the edge area of sound opening 23 and protrude to below diaphragm 21, so that bar-like structural elements 27 form a substrate-side stop 29 for diaphragm 21. FIG. 4b illustrates the layer structure of component 20. FIG. 4b shows the mode of action of substrate-side stop 29.

In the exemplary embodiment illustrated here, bar-like structural elements 27 together with sound opening 23 have been produced in a trenching process, starting from the rear side of the substrate. The rear side of the substrate together with bar-like structural elements 27 in the edge area has been masked corresponding to the shape of sound opening 23. Consequently, the bar-like projections extend over the entire thickness of substrate 1.

Component 20 includes four such bar-like structural elements 27, each of which is situated approximately centrally with respect to one of spring elements 22 and protrudes inwardly, starting from the edge of sound opening 23. At this point, however, it is expressly noted that the number and configuration of bar-like structural elements 27 may also be selected independently of the number and position of spring elements 22. In addition, the width and length of structural elements 27 may be different, provided that they form a substrate-side stop for diaphragm 21, and microphone component 20 has the required acoustic properties.

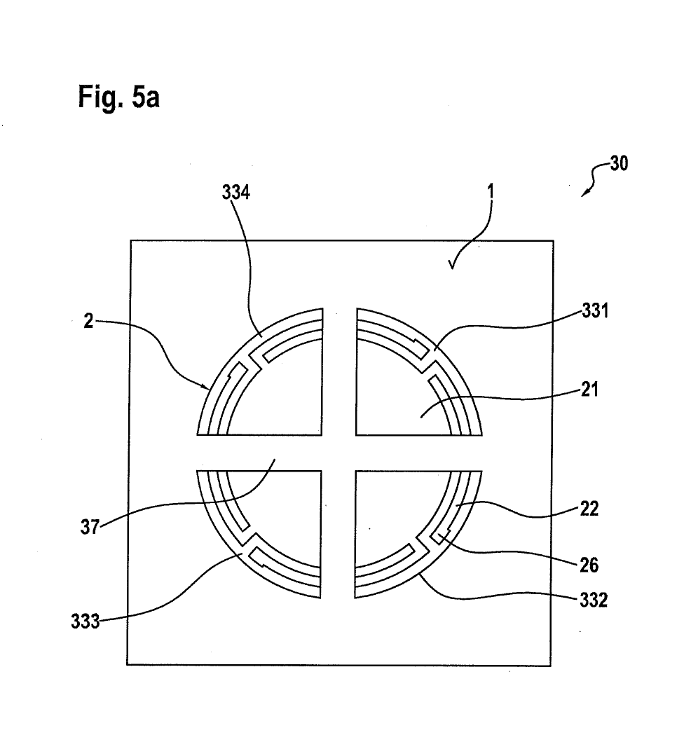

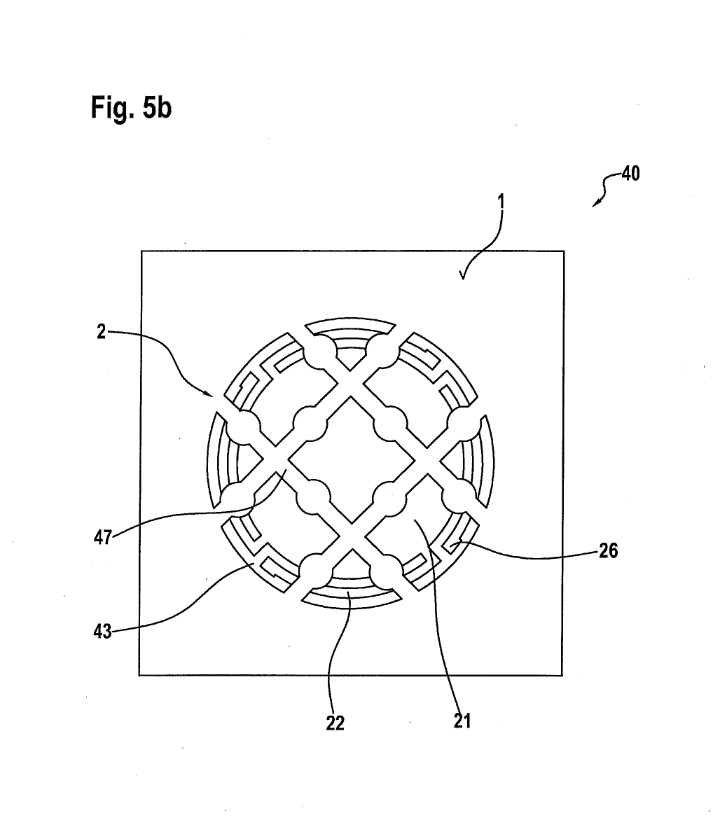

Thus, FIGS. 5a and 5b show two component variants 30 and 40, respectively, which differ from MEMS microphone component 20 illustrated in FIGS. 4a and 4b solely in the shape of the bar-like structural elements in the edge area of the sound opening.

Component 30 includes two bar-like structural elements 37 in the edge area of the sound opening, each of which extends from one side of the sound opening to the opposite side, and which thus divide the sound opening into four circular segment-shaped partial openings 331 through 334.

In the case of component 40, a lattice-like structure which is formed from four bar-like structural elements 47 which have thickened areas in places and which extend over entire sound opening 43 is situated in the area of sound opening 43.

Since components 30 and 40 are otherwise identical to component 20, reference is made to the description of FIGS. 4a and 4b with regard to the remaining component elements.

1-7. (canceled)

8. A component having a micromechanical microphone structure which is implemented in a layer structure on a semiconductor substrate, comprising:
a diaphragm structure having an acoustically active diaphragm, the diaphragm structure being formed in a diaphragm layer above the semiconductor substrate and spanning at least a portion of a sound opening in a rear side of the substrate;
substrate-side overload protection for the diaphragm structure; and
a stationary, acoustically permeable counter element which is formed in the layer structure above the diaphragm layer;
wherein outwardly protruding projections are formed at the outer edge area of the diaphragm structure which protrude beyond the edge area of the sound opening, so that the edge area of the sound opening acts as a substrate-side stop for the diaphragm structure.

9. The component of claim 8, wherein the projections formed at the outer edge of the diaphragm structure include through openings.

10. The component of claim 8, wherein web-like connecting elements are formed between the projections at the outer edge of the diaphragm structure.

11. The component of claim 10, wherein the web-like connecting elements are provided with through openings between the projections of the diaphragm structure.

12. A component having a micromechanical microphone structure which is implemented in a layer structure on a semiconductor substrate, comprising:
a diaphragm structure having an acoustically active diaphragm, the diaphragm structure being formed in a diaphragm layer above the semiconductor substrate and spanning at least one sound opening in the rear side of the substrate;
substrate-side overload protection for the diaphragm structure; and
a stationary, acoustically permeable counter element which is formed in the layer structure above the diaphragm layer;
wherein bar-like structural elements are formed in the edge area of the sound opening which project to below the diaphragm structure, so that the bar-like structural elements act as a substrate-side stop for the diaphragm.

13. The component of claim 12, wherein the bar-like structural elements extend in the edge area of the sound opening essentially over the entire thickness of the substrate.

14. The component of claim 12, wherein at least one bar-like web is formed in the edge area of the sound opening, the web extending from one side of the sound opening to the opposite side.
